(19) United States
(12) Patent Application Publication
(10) Pub. No.: US 2015/0346870 A1
(43) Pub. Date: Dec. 3, 2015

(54) SMART DEVICE AND METHOD OF CONTROLLING THE SAME

(71) Applicant: DONGBU HITEK CO., LTD, Seoul (KR)

(72) Inventors: Sung Jin OH, Suwon-si (KR); Joon SONG, Seoul (KR); Han Kyung KIM, Bucheon-si (KR); Won Cheol HONG, Seoul (KR); Min Sun KIM, Seongnam-si (KR); Hyun SONG, Suwon-si (KR); Young Wook KIM, Seoul (KR)

(21) Appl. No.: 14/726,997

(22) Filed: Jun. 1, 2015

(30) Foreign Application Priority Data
Jun. 3, 2014 (KR) 10-2014-0067759
Jul. 29, 2014 (KR) 10-2014-0096215
Jul. 30, 2014 (KR) 10-2014-0097274

(51) Int. Cl. G06F 3/044; G06F 1/32; G06F 3/047; G06F 3/0488; G06F 3/041; G06F 3/045

(52) U.S. Cl. CPC G06F 3/044; G06F 3/0412; G06F 3/045; G06F 3/047; G06F 3/04883; G06F 1/3287; G06F 2203/04101; G06F 2203/04104; G06F 2203/04808; G06F 2203/04111

(57) ABSTRACT

According to embodiments, smart devices and methods of controlling the same are disclosed. The smart device can include a touch panel; a display panel disposed on or under the touch panel; a touch integrated circuit (IC) configured to sense electrical signals from the touch panel; and an application processor configured to operate an application program according to the electrical signals. When a gesture is input onto the touch panel while the display panel is maintained in an OFF state, the smart device executes an event corresponding to an input gesture, wherein while the even is executed, the OFF state of the display panel is maintained.

### CROSS-REFERENCE TO RELATED APPLICATION

This application claims the benefit of Korean Patent Application No. 10-2014-0067759 filed on Jun. 3, 2014, Korean Patent Application No. 10-2014-0096215 filed on Jul. 29, 2014, and Korean Patent Application No. 10-2014-0097274 filed on Jul. 30, 2014, and all the benefits accruing therefrom under 35 U.S.C. §119, the contents of which are incorporated by reference in their entirety.

### BACKGROUND

The present disclosure relates to a smart device and a method of controlling the same. More particularly, the present disclosure relates to a smart device that includes a touch panel and a display panel, and a method of controlling the same.

A touch panel may be used as an input device of a smart device that includes a display panel and an application processor. The touch panel may be classified into a resistive type, a capacitive type, or an electromagnetic type and the like.

For example, a touch panel of a mutual capacitance type may detect a touch location by measuring a mutual capacitance varying by the touch of a conductor between a driving line and a sensing line.

The touch panel of the mutual capacitance type may include a plurality of driving lines and a plurality of sensing lines that cross the driving lines. When driving signals are sequentially applied to the driving lines, a mutual capacitance generated by the applying of the driving signals may be detected from the sensing lines. The driving lines and the sensing lines may be connected to a touch integrated circuit (IC), and the touch IC may apply the driving signals and obtain touch signals from the sensing lines.

When an application program is not executed or a music playback program such as a music player is executed, a standby mode in which the display panel and the touch panel are changed to an OFF state may be used in order to decrease the power consumption of the smart device. The standby mode may be ended by the input of a password or a predetermined touch pattern.

For example, Korean Laid-Open Patent Publication No. 10-2009-058875 discloses a method of inputting a predetermined touch pattern to end the standby mode and thus change a display panel to an ON state. However, even when the operation of the display panel is not needed, such as when the music playback program such as a music player is used or when a ring mode or vibration mode is selected, the display panel is unnecessarily changed to the ON state and thus power consumption may increase. Also, there is a limitation in that the touch panel should be maintained in an ON state in order to sense the touch pattern.

### SUMMARY

The present disclosure provides a smart device that may decrease power consumption, and a method of controlling the same.

In accordance with an aspect of the claimed invention, a smart device may include a touch panel, a display panel coupled to the touch panel, a touch integrated circuit (IC) configured to sense electrical signals from the touch panel, and an application processor configured to operate an application program according to the electrical signals. When a gesture is input onto the touch panel while the display panel is maintained in an OFF state, an event corresponding to the input gesture may be executed. Particularly, while the event is executed, the OFF state of the display panel may be maintained.

In accordance with some exemplary embodiments, the touch IC may include a touch driver configured to provide the touch panel with driving signals, a signal processing unit configured to receive electrical signals generated by the input gesture from the touch panel and convert the electrical signals to digital signals, and a control unit configured to transmit a command for executing the event to the application processor according to the digital signals.

In accordance with some exemplary embodiments, the control unit may compare the input gesture with predetermined gestures and select a gesture corresponding to the input gesture from among the predetermined gestures. At this time, the selected gesture corresponds to the event.

In accordance with some exemplary embodiments, the touch panel may include first driving lines, second driving lines interdigitated with the first driving lines, respectively, and sensing lines crossing the first and second driving lines, and the touch IC may provide the first or second driving lines with driving signals and receive sensing signals from the sensing lines.

In accordance with some exemplary embodiments, the touch IC may provide the first driving lines with first driving signals to obtain first scan data from the sensing lines and provide the second driving lines with second driving signals to obtain second scan data from the sensing lines.

In accordance with some exemplary embodiments, the touch panel may include first sensing lines crossing the first and second driving lines and second sensing lines interdigitated with the first sensing lines, respectively.

In accordance with some exemplary embodiments, the touch IC may provide the first driving lines with first driving signals to obtain first scan data from the first sensing lines, provide the first driving lines with second driving signals to obtain second scan data from the second sensing lines, provide the second driving lines with third driving signals to obtain third scan data from the first sensing lines, and provide the second driving lines with fourth driving signals to obtain fourth scan data from the second sensing lines.

In accordance with some exemplary embodiments, the touch panel may include driving lines, first sensing lines crossing the driving lines and second sensing lines interdigitated with the first sensing lines, respectively, and the touch IC may provide the driving lines with driving signals and receive sensing signals from the first or second sensing lines.

In accordance with some exemplary embodiments, the touch IC may provide the driving lines with first driving signals to obtain first scan data from the first sensing lines and provide the driving lines with second driving signals to obtain second scan data from the second sensing lines.

In accordance with some exemplary embodiments, the touch panel may include a plurality of touch areas, and the touch IC may provide driving lines passing through any one selected from the touch areas with driving signals.

In accordance with some exemplary embodiments, the touch IC may receive sensing signals from sensing lines passing through the selected touch area.

In accordance with another aspect of the claimed invention, a method of controlling a smart device may include inputting a gesture onto a touch panel and executing an event corresponding to the input gesture. At this time, the inputting of the gesture and the executing of the event may be performed while a display panel of the smart device is in an OFF state.

In accordance with some exemplary embodiments, the event may include an application program capable of being operated in the OFF state of the display panel and a configuration program of the smart device.

In accordance with some exemplary embodiments, the application program may include a music playback program, a flash ON/OFF program, a phone calling program, a music search program, a weather search program, a recording program, a radio program and a voice navigation program.

In accordance with some exemplary embodiments, the configuration program may include a WiFi mode, a Bluetooth mode, a near field communication (NFC) mode, a ring mode, and a vibration mode.

In accordance with some exemplary embodiments, the method may further include comparing the input gesture with predetermined gestures, selecting a gesture corresponding to the input gesture from among the predetermined gestures, and transmitting a command corresponding to a selected gesture to an application processor of the smart device to execute the event.

In accordance with some exemplary embodiments, the method may further include sensing the input gesture.

In accordance with some exemplary embodiments, the touch panel may include first driving lines, second driving lines interdigitated with the first driving lines, respectively, and sensing lines crossing the first and second driving lines, and the gesture may be detected by sensing signals received from the sensing lines after providing the first or second driving lines with driving signals.

In accordance with some exemplary embodiments, the sensing of the input gesture may include providing the first driving lines with first driving signals to obtain first scan data from the sensing lines and providing the second driving lines with second driving signals to obtain second scan data from the sensing lines.

In accordance with some exemplary embodiments, the first and second driving signals may be sequentially provided for the first and second driving lines, respectively.

In accordance with some exemplary embodiments, a predetermined number of the first and second driving signals may be simultaneously provided for the first and second driving lines, respectively.

In accordance with some exemplary embodiments, the touch panel may include first sensing lines crossing the first and second driving lines and second sensing lines interdigitated with the first sensing lines.

In accordance with some exemplary embodiments, the sensing of the input gesture may include providing the first driving lines with first driving signals to obtain first scan data from the first sensing lines, providing the first driving lines with second driving signals to obtain second scan data from the second sensing lines, providing the second driving lines with third driving signals to obtain third scan data from the first sensing lines, and providing the second driving lines with fourth driving signals to obtain fourth scan data from the second sensing lines.

In accordance with some exemplary embodiments, the touch panel may include driving lines, first sensing lines crossing the driving lines and second sensing lines interdigitated with the first sensing lines, respectively, and the gesture may be detected by sensing signals received from the first or second sensing lines after providing the driving lines with driving signals.

In accordance with some exemplary embodiments, the sensing of the input gesture may include providing the driving lines with first driving signals to obtain first scan data from the first sensing lines and providing the driving lines with second driving signals to obtain second scan data from the second sensing lines.

In accordance with some exemplary embodiments, the touch panel may include a plurality of touch areas, and driving signals may be provided for driving lines passing through any one selected from the touch areas.

In accordance with some exemplary embodiments, sensing signals may be received from sensing lines passing through the selected touch area.

In accordance with some exemplary embodiments, the gesture may be input while a conductor is in contact with the touch panel or the conductor is spaced apart from the touch panel.

### BRIEF DESCRIPTION OF THE DRAWINGS

Exemplary embodiments can be understood in more detail from the following description taken in conjunction with the accompanying drawings, in which:

FIG. 1 is a block diagram illustrating a smart device in accordance with an exemplary embodiment;

FIG. 2 is a schematic view illustrating a touch panel and a touch integrated circuit (IC) in FIG. 1;

FIGS. 3 to 15 are schematic views illustrating gestures and events;

FIG. 16 is a schematic view illustrating programs apportioned to touch areas;

FIGS. 17 and 18 are schematic views illustrating a partial scan mode of a touch panel;

FIG. 19 is a schematic view illustrating a full scan mode of a touch panel;

FIGS. 20 to 23 are schematic views illustrating another example of a partial scan mode;

FIGS. 24 and 25 are schematic views illustrating still another example of a partial scan mode;

FIGS. 26 and 27 are schematic views illustrating still another example of a partial scan mode;

FIGS. 28 and 29 are schematic views illustrating still another example of a partial scan mode; and

FIG. 30 is a flowchart illustrating a method of controlling a smart device in accordance with an exemplary embodiment.

While embodiments are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF EMBODIMENTS

The claimed invention is described below in detail with reference to the accompanying drawings that show embodiments. However, the present invention does not need to be configured as represented in embodiments to be described below and may be implemented in many different forms. The following embodiments are provided to fully convey the scope of the claimed invention to a person skilled in the art to which it pertains.

When it is described that a component is arranged on or connected to another component or layer, the former may also be arranged directly on or connected directly to the latter or other components or layers may also be in between. On the other hand, when it is described that a component is arranged directly on or connected directly to another component, there may be no component in between. Although the terms ‘a first’ and ‘a second’ may be used in order to describe various items such as various components, compositions, regions, layers and/or parts, the items are not limited by these terms.

The special terms used herein are only used for the purpose of describing particular embodiments and not intended to limit the claimed invention. Also, all terms including technological and scientific terms have the same meanings as those that may be understood by a person skilled in the art to which the claimed invention pertains, unless otherwise specified. The terms such as those defined in ordinary dictionaries are construed as having the same meanings in contexts of the related art and the claimed invention and not construed as an explicit intuition ideally or excessively unless clearly specified.

Embodiments of the claimed invention are described with reference to schematic diagrams of the ideal embodiments of the claimed invention. Thus, changes in shapes of the diagrams such as changes in manufacturing methods and/or tolerances are may be sufficiently predicted. Thus, the embodiments of the claimed invention are not described to be limited to particular shapes of illustrated regions but include the differences in shapes, and regions shown in the drawings are entirely schematic and their shapes are not intended to describe the accurate shape of a region nor limit the scope of the claimed invention.

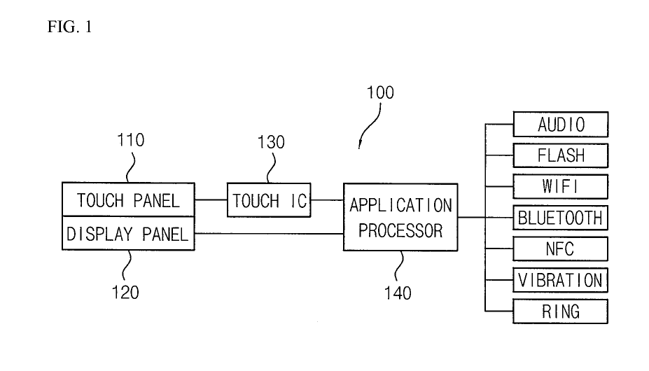

FIG. 1 is a block diagram illustrating a smart device in accordance with an exemplary embodiment.

Referring to FIG. 1, a smart device 100 in accordance with an exemplary embodiment may include a touch panel 110, a display panel 120 coupled to the touch panel 110, a touch integrated circuit (IC) 130 for sensing electrical signals from the touch panel 110, and an application processor 140 for operating an application program according to the electrical signals. The application program may include a music playback program, a flash ON/OFF program, a phone calling program, a music search program, a weather search program, a recording program, a radio program, a voice navigation program, and the like. Further, the application program may include a configuration program including a WiFi mode, a Bluetooth mode, a near field communication mode, a ring mode, a vibration mode, and the like.

For example, a touch panel 110 of a mutual capacitance type may be used as the touch panel 110, and the display panel 120 may be disposed on or under the touch panel 110.

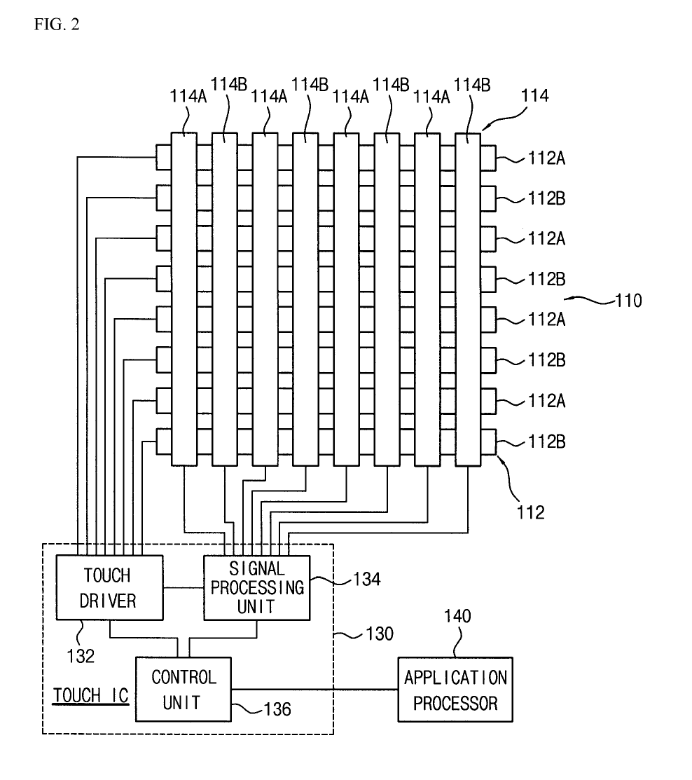

FIG. 2 is a schematic view illustrating a touch panel and the touch IC as shown in FIG. 1.

Referring to FIG. 2, the touch panel 110 may include driving lines 112 and sensing lines 114 crossing the driving lines 112. Particularly, the touch panel 110 may include first driving lines 112A, second driving lines 112B interdigitated with the first driving lines 112A, first sensing lines 114A crossing the first and second driving lines 112A and 112B, and second sensing lines 114B interdigitated with the first sensing lines 114A, respectively. For example, odd driving lines may be used as the first driving lines 112A and even driving lines may be used as the second driving lines 112B, as shown in FIG. 2. Further, odd sensing lines may be used as the first sensing lines 114A and even sensing lines may be used as the second sensing lines 114B.

The touch IC 130 may include a touch driver 132 that provides the driving lines 112 of the touch panel 110 with driving signals, a signal processing unit 134 that receives electrical signals, i.e., sensing signals, from the sensing lines 114 of the touch panel 110 and converts the electrical signals into digital signals, and a control unit 136 that transmits a command to the application processor 140 according to the digital signals.

According to an exemplary embodiment, the smart device 100 may execute a low-power mode to decrease power consumption and the display panel 120 may be changed to an OFF state in the low-power mode.

For example, the low-power mode may also be executed through the power button (not shown) of the smart device 100 or when a state in which a touch signal is not input is maintained for a predetermined time, the low-power mode may automatically executed. In particular, even while a music playback program such as a music player is executed, the low-power mode may be executed.

When a gesture by a user is input through the touch panel 110 during the execution of the low-power mode as described above, the smart device 100 may execute an event corresponding to an input gesture. In particular, even when the event is performed, the OFF state of the display panel 120 may be maintained to decrease power consumption.

The event may include functions of an application program that operates in a state in which the display panel 120 is turned off, or a configuration program of the smart device 100. For example, the application program may include a music playback program, a flash ON/OFF program, a phone calling program, a music search program, a weather search program, a recording program, a radio program, a voice navigation program, and the like. The configuration program may include a WiFi mode, a Bluetooth mode, a near field communication mode, a ring mode, a vibration mode, and the like.

The music playback program may be executed in a state that the display panel 120 is turned off, and the Flash ON/OFF program may be used to operate a flash in a state that the display panel is turned off in a dark environment. Further, the events such as a phone calling, a music search, a weather search, a radio ON/Off, a recording and a voice navigation may be executed in a state that the display panel 120 is turned off.

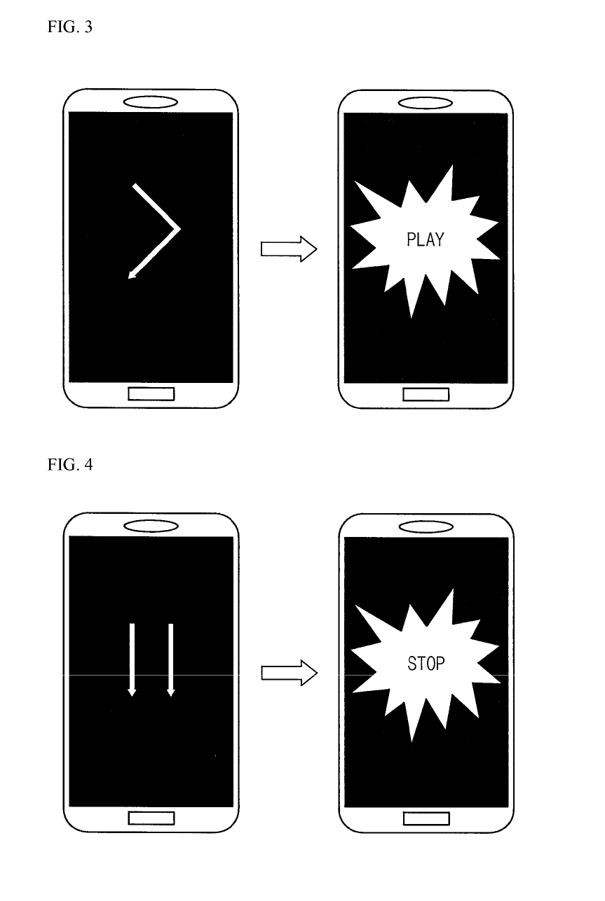

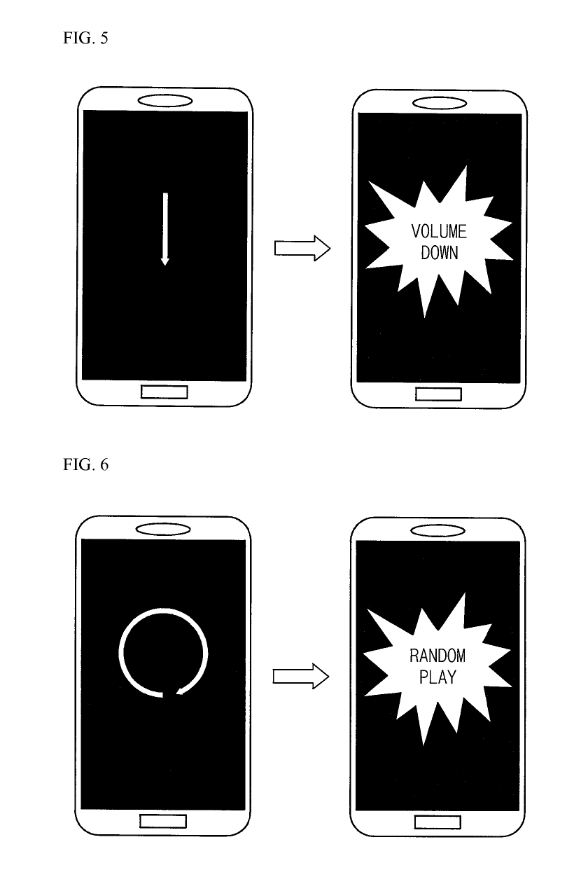

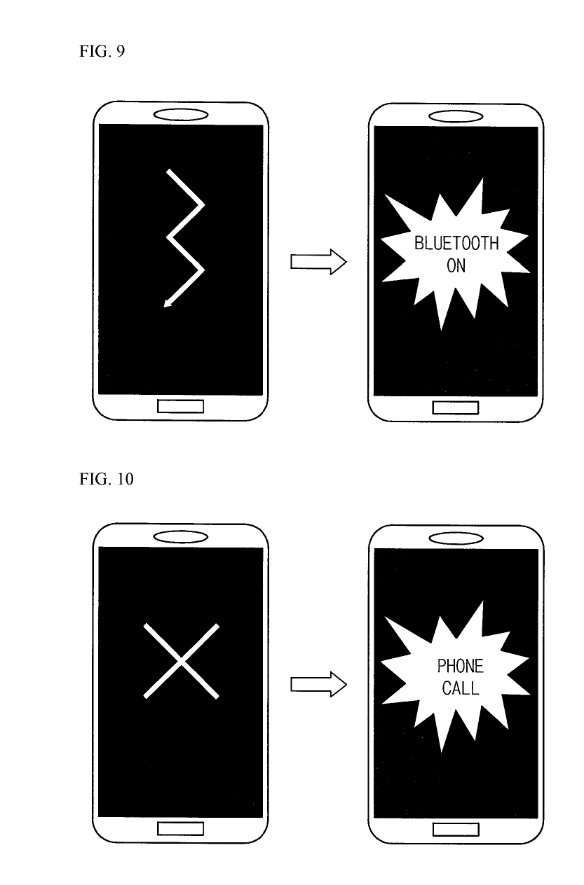

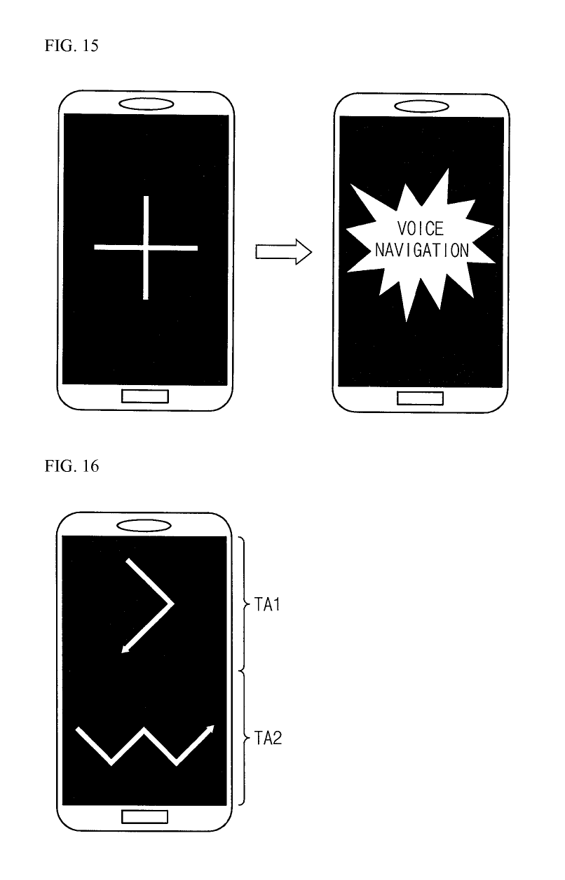

FIGS. 3 to 15 are schematic views illustrating gestures and events.

The control unit 136 may set up various gestures and commands corresponding to the gestures, and the application processer 140 may execute the events corresponding to the commands.

For example, it is possible to execute play, stop, or volume up/down and set up random play, repeat play or continuous play in the music playback program as shown in FIGS. 3 to 6.

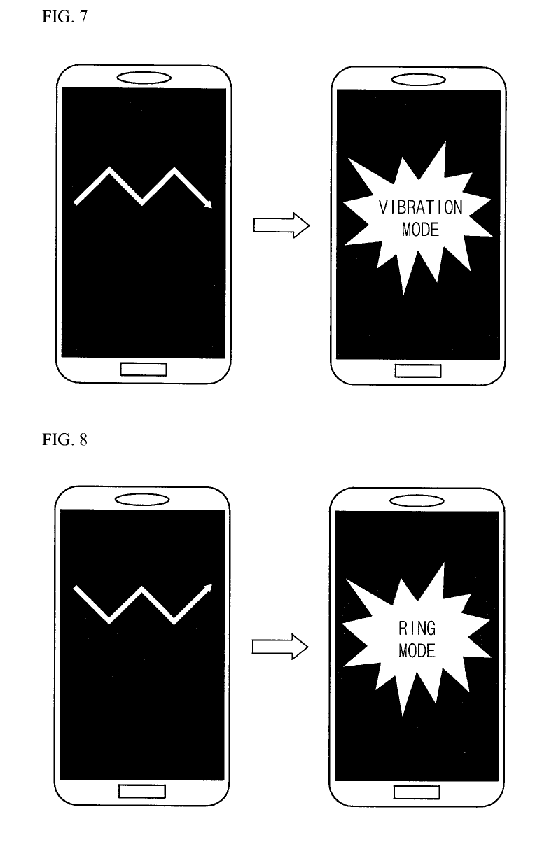

Referring to FIGS. 7 to 9, it is possible to set up a vibration mode, a ring mode, or Bluetooth ON/OFF in the configuration program.

Referring to FIG. 10, it is possible to execute a phone call by inputting a gesture. In this case, a telephone number corresponding to the phone call gesture may be set up in advance.

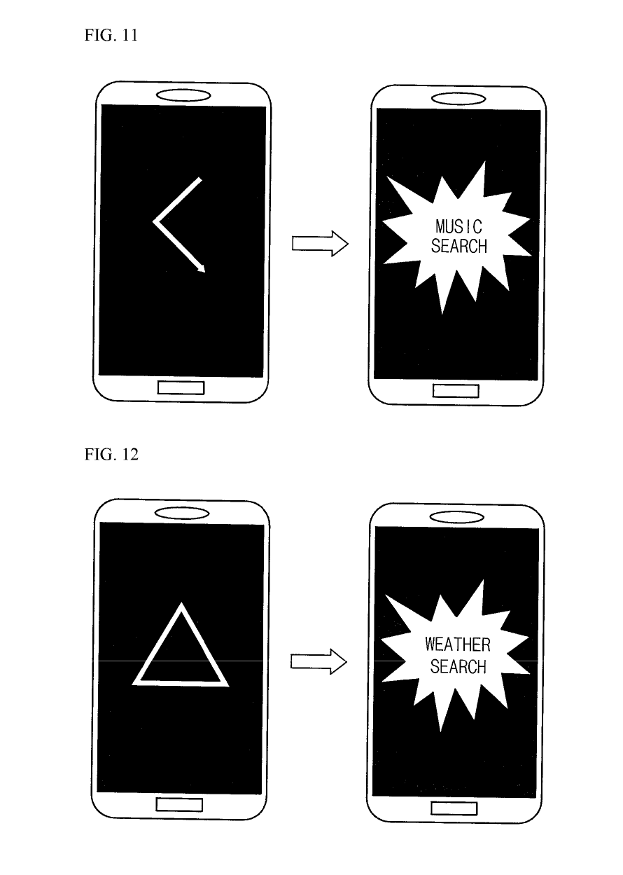

Referring to FIG. 11, a music search program may be executed by inputting a gesture. For example, a music corresponding to a voice or sound input through a microphone may be searched, and the search result may then be output by a speaker.

Referring to FIG. 12, a weather search program may be executed by inputting a gesture. For example, weather information may be searched by inputting a gesture, and the search result may then be output by a speaker.

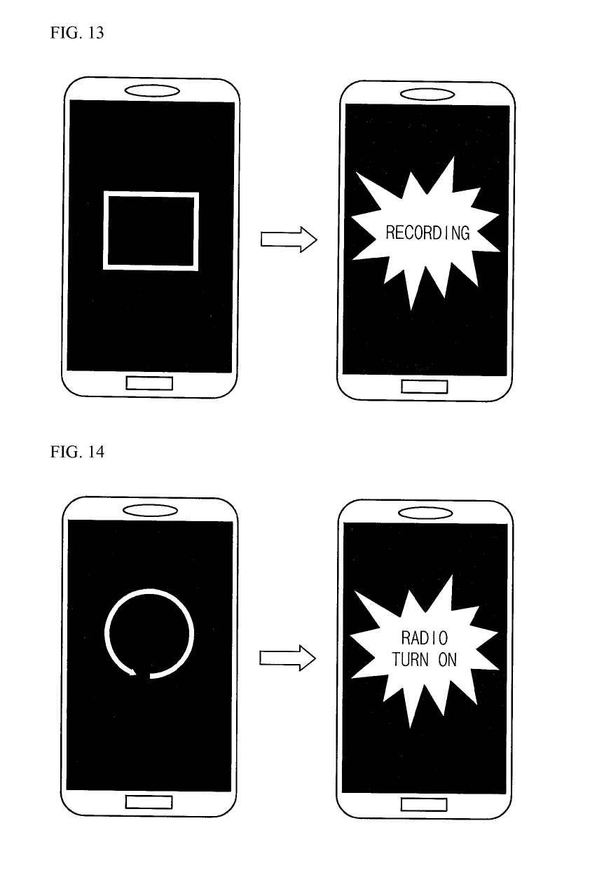

Referring to FIGS. 13 to 15, a recording program, a radio program, a voice navigation program, and the like may be executed by inputting gestures.

Although not shown, various gestures and events corresponding thereto may be set up, and thus the scope of the claimed invention is not limited by the gestures and events as described above.

FIG. 16 is a schematic view illustrating programs apportioned to touch areas.

Referring to FIG. 16, the touch panel 110 may include a plurality of touch areas. For example, the touch panel 110 may include a first touch area TA1 and a second touch area TA2 as shown in FIG. 16. The application program and the configuration program may be apportioned to the first and second touch areas TA1 and TA2, respectively.

Referring back to FIG. 2, the signal processing unit 134 may receive electrical signals generated by the input gesture, convert the electrical signals into digital signals, and transmit the digital signals to the control unit 136. The control unit 136 may transmit a command corresponding to the event to the application processor 140 according to the digital signals.

In particular, the control unit 136 may compare the input gesture with the predetermined gestures, select a gesture corresponding to the input gesture from among the predetermined gestures, and transmit a command corresponding to a selected gesture to the application processor 140 to execute the event.

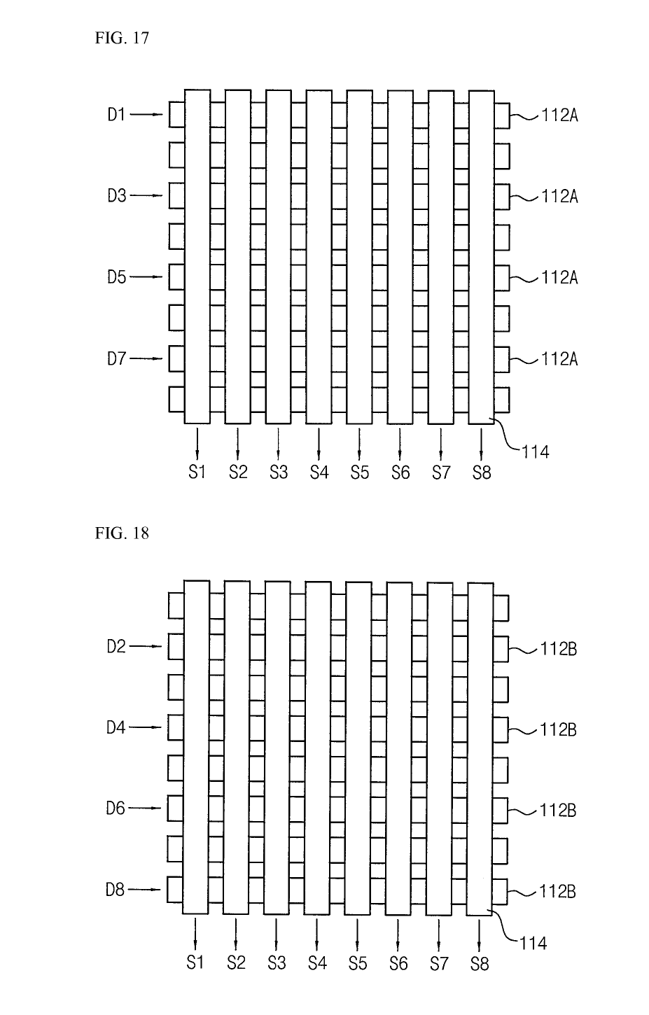

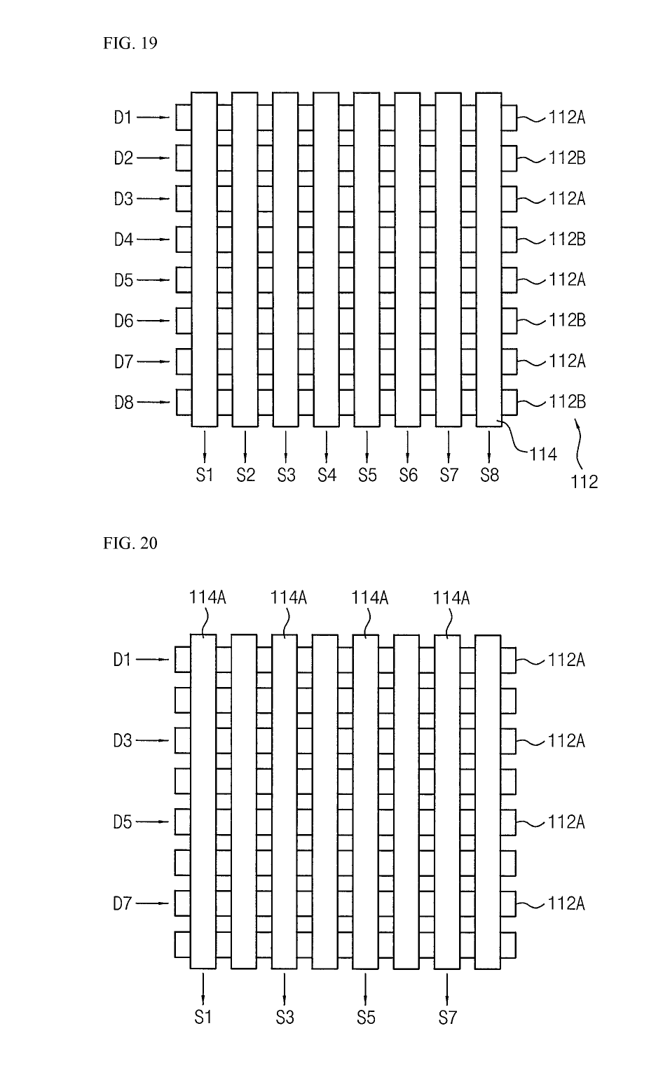

FIGS. 17 and 18 are schematic views illustrating a partial scan mode of a touch panel and FIG. 19 is a schematic view illustrating a full scan mode of a touch panel.

Referring to FIGS. 17 and 18, while the display panel 120 is operated in the low-power mode, i.e., the display panel 120 is maintained in the OFF state, the input gesture may be sensed by the control unit 136. At this time, the touch panel 110 may operate in a partial scan mode. That is, the partial scan mode of the touch panel 110 may be used to detect the gesture while the display panel 120 is maintained in the OFF state.

In accordance with an exemplary embodiment, driving signals may be provided for the first or second driving lines 112A or 112B to detect the gesture while the partial scan mode is executed, and sensing signals corresponding to the driving signals may be received from the sensing lines 114.

For example, first scan data constituting a first frame may include sensing signals received from the sensing lines 114 after sequentially providing the first driving lines 112A with the driving signals as shown in FIG. 17. That is, the first scan data may include sensing signal S1-S8 received after providing driving signal D1, sensing signal S1-S8 received after providing driving signal D3, sensing signal S1-S8 received after providing driving signal D5, and sensing signal S1-S8 received after providing driving signal D7.

Further, second scan data constituting a second frame may include sensing signals received from the sensing lines 114 after sequentially providing the second driving lines 112B with the driving signals as shown in FIG. 18. That is, the second scan data may include sensing signal S1-S8 received after providing driving signal D2, sensing signal S1-S8 received after providing driving signal D4, sensing signal S1-S8 received after providing driving signal D6, and sensing signal S1-S8 received after providing driving signal D8.

The control unit 136 may repetitively obtain the first scan data and the second scan data in order to sense the gesture.

As described above, each of the first and second frames consists of sensing signals received from the sensing lines 114 after the driving signals are selectively provided for the first or second driving lines 112A or 112B, and thus the power consumption of the touch panel 110 may significantly decrease. In particular, since the display panel 120 may be maintained in the OFF state even if the event is executed, the power consumption of the smart device 100 may sufficiently decrease.

When the display panel 120 is changed to an ON state by a user, the touch panel 110 may operate in a full scan mode. The full scan mode may be used to enhance the linearity and accuracy of the touch panel 110. In particular, as shown in FIG. 19, the driving lines 112 may be sequentially provided with driving signals D1-D8 and scan data may be obtained by using sensing signals S1-S8 received from the sensing lines 114. That is, all the driving lines 112 may be sequentially provided with the driving signals every frame.

In accordance with another exemplary embodiment, when a touch signal is detected by the control unit 136, the touch panel 110 may be changed from the partial scan mode to the full scan mode to accurately sense the gesture. However, the display panel 120 may be maintained in the OFF state even in this case, and thus the power consumption of the smart device 100 may significantly decrease. When there is no gesture input for a predetermined time after the touch panel 110 is changed to the full scan mode, the touch panel 110 may be changed from the full scan mode to the partial scan mode.

In accordance with still another exemplary embodiment, a predetermined number of driving signals may be simultaneously provided for the first or second driving lines 112A or 112B, respectively. For example, referring to FIG. 17, a plurality of first driving signals D1 and D3 may be simultaneously provided for the first driving lines 112A, and then a plurality of first driving signals D5 and D7 may be simultaneously provided for the first driving lines 112A. Further, referring to FIG. 18, a plurality of second driving signals D2 and D4 may be simultaneously provided for the second driving lines 112B, and then a plurality of second driving signals D6 and D8 may be simultaneously provided for the second driving lines 112B.

The gesture may be input while a conductor such as a user's hand is in contact with the touch panel 110 or the conductor is spaced apart from the touch panel 110. That is, the gesture may be input by dragging the conductor while the conductor is in contact or non-contact with the touch panel. In the case of non-contact, the gap between the conductor and the touch panel 110 may be several millimeters to several centimeters. For example, the gap between the conductor and the touch panel 110 may be approximately 5 millimeters to approximately 5 centimeters.

FIGS. 20 to 23 are schematic views illustrating another example of a partial scan mode.

Referring to FIGS. 20 to 23, while the touch panel 110 is operated in the partial scan mode, the touch driver 132 may selectively provide the first or second driving lines 112A or 112B with driving signals, and the signal processing unit 134 may selectively receive sensing signals from the first or second sensing lines 114A or 114B.

For example, first scan data constituting a first frame may include sensing signals received from the first sensing lines 114A after sequentially providing the first driving lines 112A with the driving signals as shown in FIG. 20. That is, the first scan data may include sensing signal S1, S3, S5, and S7 received from the first sensing lines 114A after providing driving signal D1, sensing signal S1, S3, S5, and S7 received from the first sensing lines 114A after providing driving signal D3, sensing signal S1, S3, S5, and S7 received from the first sensing lines 114A after providing driving signal D5, and sensing signal S1, S3, S5, and S7 received from the first sensing lines 114A after providing driving signal D7.

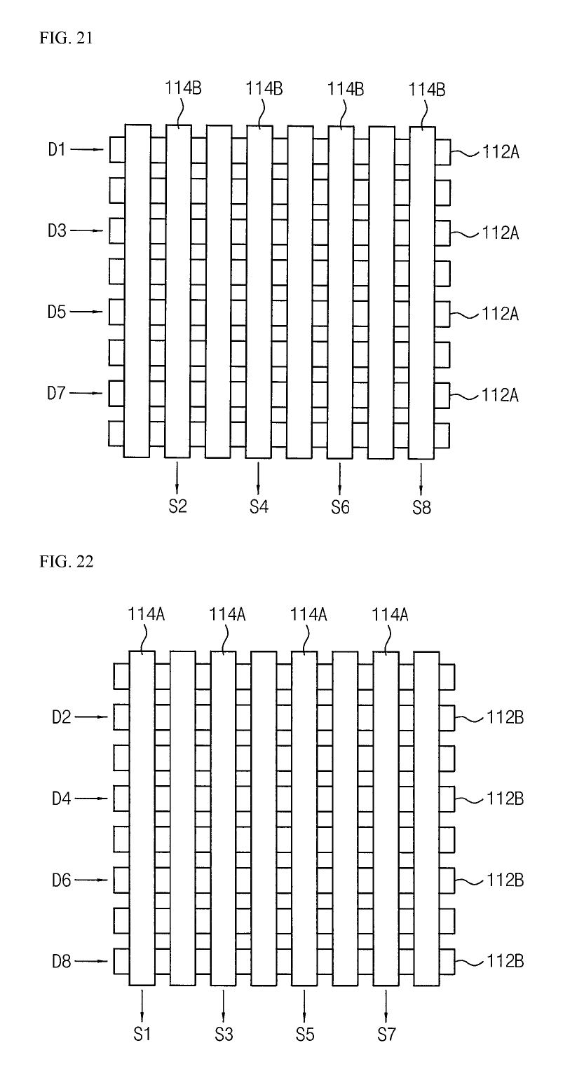

Second scan data constituting a second frame may include sensing signals received from the second sensing lines 114B after sequentially providing the first driving lines 112A with the driving signals as shown in FIG. 21. That is, the second scan data may include sensing signal S2, S4, S6, and S8 received from the second sensing lines 114B after providing driving signal D1, sensing signal S2, S4, S6, and S8 received from the second sensing lines 114B after providing driving signal D3, sensing signal S2, S4, S6, and S8 received from the second sensing lines 114B after providing driving signal D5, and sensing signal S2, S4, S6, and S8 received from the second sensing lines 114B after providing driving signal D7.

Third scan data constituting a third frame may include sensing signals received from the first sensing lines 114A after sequentially providing the second driving lines 112B with the driving signals as shown in FIG. 22. That is, the third scan data may include sensing signal S1, S3, S5, and S7 received from the first sensing lines 114A after providing driving signal D2, sensing signal S1, S3, S5, and S7 received from the first sensing lines 114A after providing driving signal D4, sensing signal S1, S3, S5, and S7 received from the first sensing lines 114A after providing driving signal D6, and sensing signal S1, S3, S5, and S7 received from the first sensing lines 114A after providing driving signal D8.

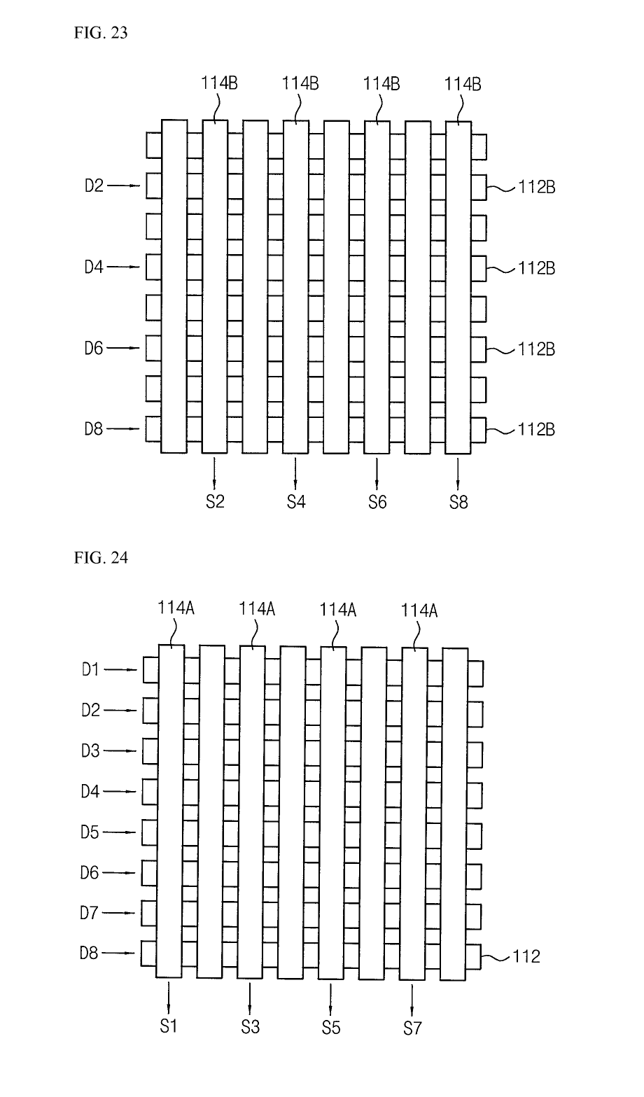

Fourth scan data constituting a fourth frame may include sensing signals received from the second sensing lines 114B after sequentially providing the second driving lines 112B with the driving signals as shown in FIG. 23. That is, the fourth scan data may include sensing signal S2, S4, S6, and S8 received from the second sensing lines 114B after providing driving signal D2, sensing signal S2, S4, S6, and S8 received from the second sensing lines 114B after providing driving signal D4, sensing signal S2, S4, S6, and S8 received from the second sensing lines 114B after providing driving signal D6, and sensing signal S2, S4, S6, and S8 received from the second sensing lines 114B after providing driving signal D8.

The control unit 136 may repetitively obtain the first, second, third and fourth scan data in order to sense the gesture. At this time, the sequence which obtains the first, second, third and fourth scan data may be changed, and thus the scope of the claimed invention is not limited by the sequence.

As described above, each of the frames consists of sensing signals received from the first or second sensing lines 114A or 114B after the driving signals are selectively provided for the first or second driving lines 112A or 112B, and thus the power consumption of the touch panel 110 may significantly decrease.

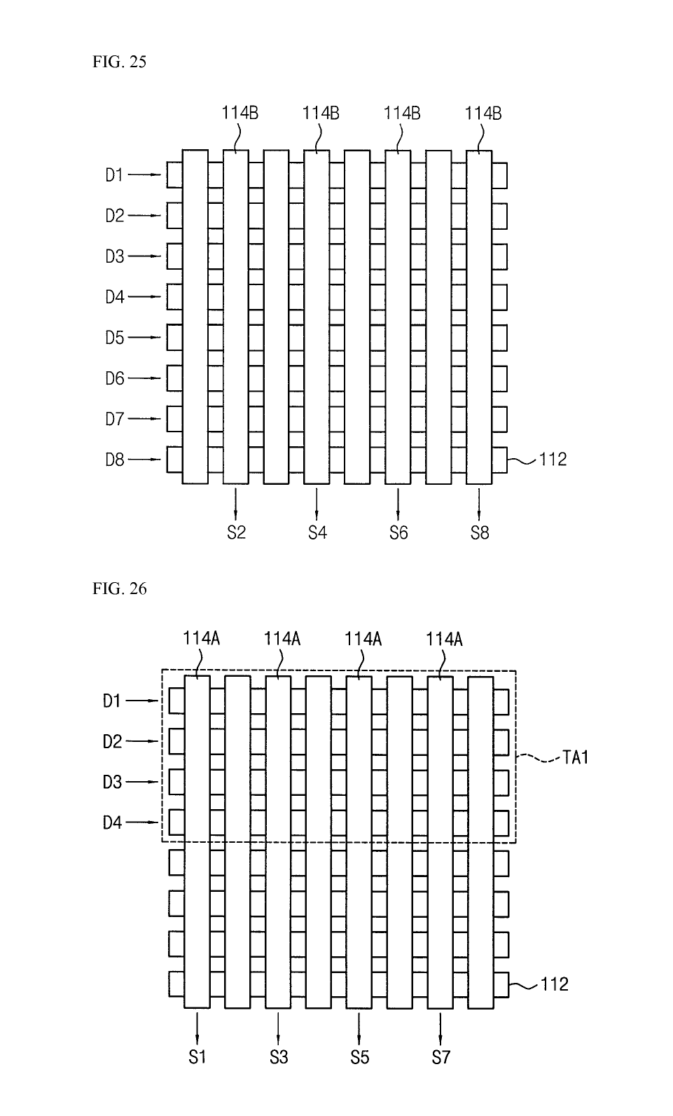

FIGS. 24 and 25 are schematic views illustrating still another example of a partial scan mode.

Referring to FIGS. 24 and 25, while the touch panel 110 is operated in the partial scan mode, the touch driver 132 may selectively provide the driving lines 112 with driving signals, and the signal processing unit 134 may selectively receive sensing signals from the first or second sensing lines 114A or 114B.

For example, first scan data constituting a first frame may include sensing signals S1, S3, S5, and S7 received from the first sensing lines 114A after sequentially providing the driving lines 112 with the driving signals D1-D8 as shown in FIG. 24. That is, the first scan data may include sensing signal S1, S3, S5, and S7 received from the first sensing lines 114A after providing driving signal D1, sensing signal S1, S3, S5, and S7 received from the first sensing lines 114A after providing driving signal D2, sensing signal S1, S3, S5, and S7 received from the first sensing lines 114A after providing driving signal D3, sensing signal S1, S3, S5, and S7 received from the first sensing lines 114A after providing driving signal D4, sensing signal S1, S3, S5, and S7 received from the first sensing lines 114A after providing driving signal D5, sensing signal S1, S3, S5, and S7 received from the first sensing lines 114A after providing driving signal D6, sensing signal S1, S3, S5, and S7 received from the first sensing lines 114A after providing driving signal D7, and sensing signal S1, S3, S5, and S7 received from the first sensing lines 114A after providing driving signal D8.

Further, second scan data constituting a second frame may include sensing signals S2, S4, S6, and S8 received from the second sensing lines 114B after sequentially providing the driving lines 112 with the driving signals D1-D8 as shown in FIG. 25. That is, the second scan data may include sensing signal S2, S4, S6, and S8 received from the first sensing lines 114A after providing driving signal D1, sensing signal S2, S4, S6, and S8 received from the first sensing lines 114A after providing driving signal D2, sensing signal S2, S4, S6, and S8 received from the first sensing lines 114A after providing driving signal D3, sensing signal S2, S4, S6, and S8 received from the first sensing lines 114A after providing driving signal D4, sensing signal S2, S4, S6, and S8 received from the first sensing lines 114A after providing driving signal D5, sensing signal S2, S4, S6, and S8 received from the first sensing lines 114A after providing driving signal D6, sensing signal S2, S4, S6, and S8 received from the first sensing lines 114A after providing driving signal D7, and sensing signal S2, S4, S6, and S8 received from the first sensing lines 114A after providing driving signal D8

The control unit 136 may repetitively obtain the first scan data and the second scan data in order to sense the gesture.

As described above, each of the first and second frames consists of sensing signals received from the first or second sensing lines 114A or 114B after the driving signals are provided for the driving lines 112, and thus the power consumption of the touch panel 110 may significantly decrease.

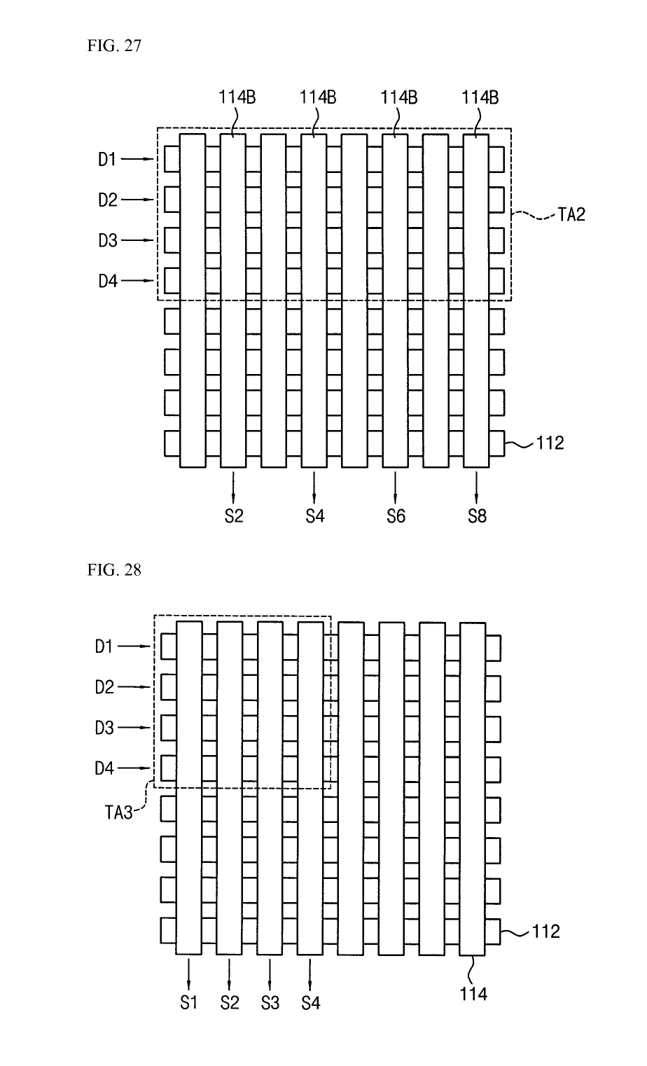

FIGS. 26 and 27 are schematic views illustrating still another example of a partial scan mode.

Referring to FIGS. 26 and 27, the touch panel 110 may include a plurality of touch areas, and the control unit 136 may select any one from the touch areas. Particularly, driving signals may be selectively provided for the selected touch area.

For example, as shown in FIG. 26, driving signals D1-D4 may be sequentially provided for driving lines 112 disposed in the selected touch area TA1, and sensing signals S1, S3, S5, and S7 may be received from the first sensing lines 114A passing through touch area TA1. Likewise, as shown in FIG. 27, driving signals D1-D4 may be sequentially provided for driving lines 112 disposed in the selected touch area TA2, and sensing signals S2, S4, S6, and S8 may be received from the second sensing lines 114B passing through the selected touch area TA2.

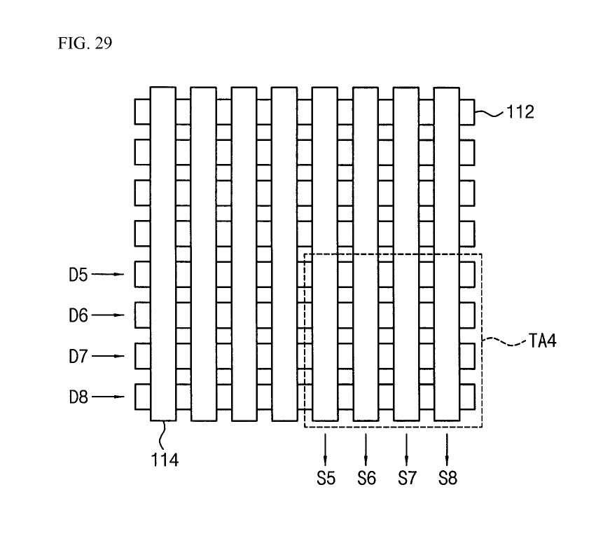

FIGS. 28 and 29 are schematic views illustrating still another example of a partial scan mode.

Referring to FIGS. 28 and 29, the touch panel 110 may include a plurality of touch areas TA3 and TA4, respectively, and the control unit 136 may select any one from the touch areas TA3 or TA4. Particularly, driving signals may be selectively provided for the selected touch area TA3 or TA4.

For example, driving signals D1-D4 or D5-D8 may be sequentially provided for driving lines 112 passing through the selected touch area TA3 or TA4 as shown in figures, and sensing signals S1-S4 or S5-S8 may be received from the sensing lines 114 passing through the selected touch area TA3 or TA4.

As described above, a multitude of diverse touch area geometries may be selectively used, and the number of the driving signals and/or the sensing signals may be reduced accordingly. Thus, the power consumption of the touch panel 110 may significantly decrease.

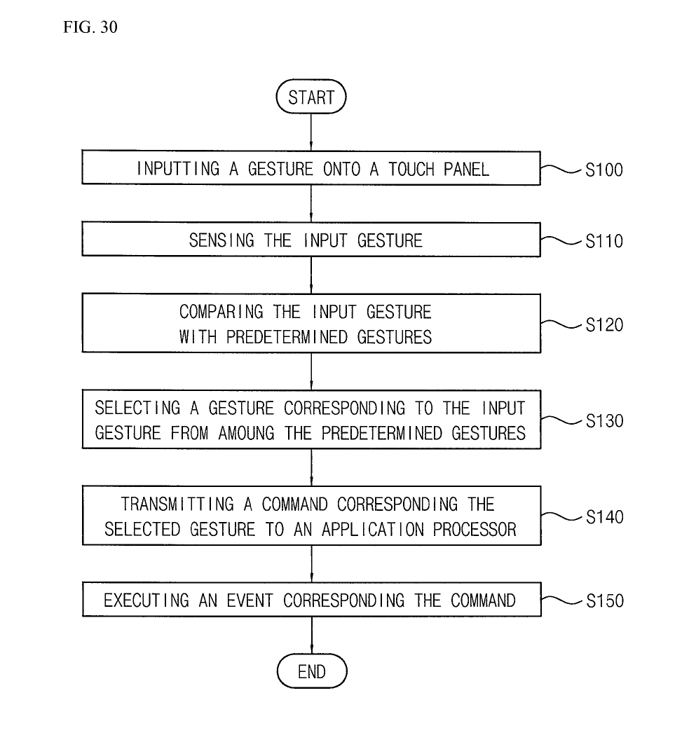

FIG. 30 is a flowchart illustrating a method of controlling a smart device in accordance with an exemplary embodiment.

Referring to FIG. 30, a gesture may be input onto the touch panel 110 in step S100. At this time, the touch panel 110 may operate in a partial scan mode, and the display panel 120 may be maintained in an OFF state.

In step S110, an input gesture may be sensed. For example, the touch driver 132 may provide the first driving lines 112A with first driving signals D1, D3, D5, and D7 (See FIG. 17), and the signal processing unit 134 may convert electrical signals received from the sensing lines 114, i.e., sensing signals S1-S8 (See FIG. 17) into first digital signals, and transmit the first digital signals to the control unit 136. Further, the touch driver 132 may provide the second driving lines 112B with second driving signals D2, D4, D6, and D8 (See FIG. 18), and the signal processing unit 134 may convert electrical signals received from the sensing lines 114, i.e., sensing signals S1-S8 (See FIG. 18) into second digital signals, and transmit the second digital signals to the control unit 136.

The control unit 136 may obtain first scan data and second scan data form the first digital signals and the second digital signals, respectively and recognize the input gesture by repetitively obtaining the first scan data and the second scan data.

The control unit 136 may compare the input gesture with predetermined gestures in step S120 and select a gesture corresponding to the input gesture from among the predetermined gestures in step S130. Then, the control unit 136 may transmit a command for executing an event corresponding to the selected gesture to the application processor 140 in step S140.

In step S150, the application processor 140 may execute the event corresponding to a transmitted command. Particularly, the display panel 120 may be maintained in an OFF state while steps S100 to S150 are performed.

In accordance with exemplary embodiments of the claimed invention as described above, while the display panel 120 is in an OFF state, a gesture may be input onto the touch panel 110, and the touch IC 130 may transmit a command corresponding to the event to the application processor 140 to execute an event corresponding to an input gesture. In particular, while the event is executed by the application processor 140, the display panel 120 may maintain an OFF state. Thus, the power consumption of the smart device 100 may significantly decrease.

Further, while the display panel 120 is maintained in the OFF state, the touch panel 110 may be operated in a partial scan mode. Particularly, driving signals may be selectively provided for first and/or second driving lines 112A and/or 112B, and sensing signals may be selectively received from first and/or second sensing lines 114A and/or 114B. Thus, power consumption of the touch panel 110 may further decrease in comparison with a full scan mode.

Although the smart device 100 and the method of controlling the same have been described with reference to the specific embodiments, they are not limited thereto. Therefore, it will be readily understood by those skilled in the art that various modifications and changes can be made thereto without departing from the spirit and scope of the claimed invention defined by the appended claims.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A smart device comprising:
a touch panel;
a display panel coupled to the touch panel;
a touch integrated circuit (IC) configured to sense electrical signals from the touch panel; and
an application processor configured to operate an application program according to the electrical signals,
wherein when a gesture is input onto the touch panel while the display panel is maintained in an OFF state, an event corresponding to the input gesture is executed, wherein while the event is executed, the OFF state of the display panel is maintained.

2. The smart device of claim 1, wherein the touch IC comprises:
a touch driver configured to provide the touch panel with driving signals;
a signal processing unit configured to receive the electrical signals generated by the input gesture from the touch panel and convert the electrical signals to digital signals; and
a control unit configured to transmit a command for executing the event to the application processor according to the digital signals.

3. The smart device of claim 2, wherein the control unit is configured to select one of a plurality of predetermined gestures corresponding to the input gesture, wherein the selected one of the plurality of predetermined gestures corresponds to the event.

4. The smart device of claim 1, wherein the touch panel comprises first driving lines and second driving lines, wherein the first and second driving lines are interdigitated with one another, and sensing lines each crossing at least one of the first driving lines and at least one of the second driving lines, and
the touch IC is configured to provide the first or second driving lines with driving signals and is further configured to receive sensing signals from the sensing lines.

5. The smart device of claim 4, wherein the touch IC is configured to provide the first driving lines with first driving signals to obtain first scan data from the sensing lines, and the touch IC is further configured to provide the second driving lines with second driving signals to obtain second scan data from the sensing lines.

6. The smart device of claim 4, wherein the touch panel comprises first sensing lines crossing both the first driving lines and the second driving lines, and wherein the touch panel further comprises second sensing lines, wherein the first and second sensing lines are interdigitated with one another.

7. The smart device of claim 6, wherein the touch IC is configured to provide the first driving lines with first driving signals to obtain first scan data from the first sensing lines, provide the first driving lines with second driving signals to obtain second scan data from the second sensing lines, provide the second driving lines with third driving signals to obtain third scan data from the first sensing lines, and provide the second driving lines with fourth driving signals to obtain fourth scan data from the second sensing lines.

8. The smart device of claim 1, wherein the touch panel comprises driving lines, first sensing lines crossing the driving lines, and second sensing lines interdigitated with the first sensing lines, and
the touch IC is configured to provide the driving lines with driving signals and receive sensing signals from the first or second sensing lines.

9. The smart device of claim 8, wherein the touch IC is configured to provide the driving lines with first driving signals to obtain first scan data from the first sensing lines and provide the driving lines with second driving signals to obtain second scan data from the second sensing lines.

10. The smart device of claim 1, wherein the touch panel comprises a plurality of touch areas, and the touch IC is configured to provide driving lines passing through a selected touch area with the driving signals.

11. The smart device of claim 10, wherein the touch IC is configured to receive sensing signals from sensing lines passing through the selected touch area.

12. A method of controlling a smart device, the method comprising:
inputting a gesture onto a touch panel; and
executing an event corresponding to the gesture,
wherein the inputting of the gesture and the executing of the event are performed while a display panel of the smart device is in an OFF state.

13. The method of claim 12, wherein the event comprises an application program capable of being operated in the OFF state of the display panel and a configuration program of the smart device.

14. The method of claim 13, wherein the application program comprises at least one of a music playback program, a flash ON/OFF program, a phone calling program, a music search program, a weather search program, a recording program, a radio program and a voice navigation program.

15. The method of claim 13, wherein the configuration program comprises at least one of a WiFi mode, a Bluetooth mode, a near field communication (NFC) mode, a ring mode, and a vibration mode.

16. The method of claim 12, further comprising:
comparing the gesture with a plurality of predetermined gestures;
selecting one of the plurality of predetermined gestures corresponding to the gesture; and
transmitting a command corresponding to the selected one of the plurality of predetermined gestures to an application processor of the smart device to execute the event.

17. The method of claim 12, further comprising sensing the input gesture.

18. The method of claim 17, wherein the touch panel comprises first driving lines, second driving lines interdigitated with the first driving lines, and sensing lines each crossing both the first and the second driving lines, and
wherein the gesture is detected by sensing signals received from the sensing lines after providing the first or the second driving lines with driving signals.

19. The method of claim 18, wherein the sensing of the input gesture comprises:
providing the first driving lines with first driving signals to obtain first scan data from the sensing lines; and
providing the second driving lines with second driving signals to obtain second scan data from the sensing lines.

20. The method of claim 19, wherein the first and second driving signals are sequentially provided for the first and second driving lines, respectively.

21. The method of claim 19, wherein a predetermined number of the first and second driving signals are simultaneously provided for the first and second driving lines, respectively.

22. The method of claim 18, wherein the touch panel comprises first sensing lines crossing the first and second driving lines and second sensing lines interdigitated with the first sensing lines.

23. The method of claim 22, wherein the sensing of the input gesture comprises:
providing the first driving lines with first driving signals to obtain first scan data from the first sensing lines;
providing the first driving lines with second driving signals to obtain second scan data from the second sensing lines;
providing the second driving lines with third driving signals to obtain third scan data from the first sensing lines; and
providing the second driving lines with fourth driving signals to obtain fourth scan data from the second sensing lines.

24. The method of claim 17, wherein the touch panel comprises driving lines, first sensing lines crossing the driving lines and second sensing lines interdigitated with the first sensing lines, and
wherein the gesture is detected by sensing signals received from the first or second sensing lines after providing the driving lines with driving signals.

25. The method of claim 24, wherein the sensing of the input gesture comprises:
providing the driving lines with first driving signals to obtain first scan data from the first sensing lines; and
providing the driving lines with second driving signals to obtain second scan data from the second sensing lines.

26. The method of claim 12, wherein the touch panel comprises a plurality of touch areas, and driving signals are provided for driving lines passing through a selected one of the touch areas.

27. The method of claim 26, wherein sensing signals are received from sensing lines passing through the selected one of the touch areas.
